(19) United States
(12) Patent Application Publication
(10) Pub. No.: US 2024/0256647 A1
(43) Pub. Date: Aug. 1, 2024

(54) AUTHENTICATION METHOD AND AUTHENTICATION APPARATUS

(71) Applicants: Beijing BOE Technology Development Co., Ltd., Beijing (CN); BOE Technology Group Co., Ltd., Beijing (CN)

(72) Inventor: Junjie ZHAO, Beijing (CN)

(21) Appl. No.: 18/564,046

(22) PCT Filed: May 23, 2022
(86) PCT No.: PCT/CN2022/094339

§ 371 Date: Nov. 24, 2023

(30) Foreign Application Priority Data
May 28, 2021 (CN) 202110592730.5

(51) Int. Cl. G06F 21/44; G16Y 30/10

(52) U.S. Cl. CPC G06F 21/44; G16Y 30/10

(57) ABSTRACT

The present disclosure relates to an authentication method and an authentication apparatus. The authentication method includes: determining a first address of a first server which is preset to be connectable with an Internet of Things (IoT) device and a second address of at least one second server which is not preset to be connectable with the IoT device; and sending a first authentication request to the at least one second server according to the second address, wherein the first authentication request at least carries authentication information of the IoT device and the first address.

This application is based on a Chinese Patent Application No. 202110592730.5 filed on May 28, 2021, and claims priority to the above Chinese Patent Application, the entire contents of which are incorporated herein by reference.

### TECHNICAL FIELD

The present disclosure relates to the field of Internet of Things (IoT) technologies, and in particular to an authentication method, an authentication apparatus, an electronic device and a computer-readable storage medium.

### BACKGROUND

With the development of IoT technologies, IoT devices have gradually become popular in daily life. After the IoT devices are connected in a network, the IoT devices can access servers provided by manufacturers to which the IoT devices belong, and the servers can perform authentication on the IoT devices.

However, current IoT devices can only access the servers provided by the manufacturers to which the IoT devices belong, resulting in certain limitations on the communication flexibility of the IoT devices.

### SUMMARY

The present disclosure provides an authentication method, an authentication apparatus, an electronic device and a computer-readable storage medium to solve the deficiencies in related art.

According to a first aspect of embodiments of the present disclosure, there is provided an authentication method, being applicable to an Internet of Things (IoT) device, including: determining a first address of a first server which is preset to be connectable with the IoT device and a second address of at least one second server which is not preset to be connectable with the IoT device; and sending a first authentication request to the at least one second server according to the second address, wherein the first authentication request at least carries authentication information of the IoT device and the first address.

According to a second aspect of the embodiments of the present disclosure, there is provided an authentication method, being applicable to a first server, including: receiving a second authentication request sent by at least one second server, wherein the second authentication request at least carries authentication information of an Internet of Things (IoT) device and a certificate of the at least one second server, the first server is a server which is preset to be connectable with the IoT device, and the at least one second server is a server which is not preset to be connectable with the IoT device: performing authentication on the at least one second server according to the certificate, and performing authentication on the IoT device according to the authentication information; and sending an authentication response to the at least one second server according to a result of authentication.

According to a third aspect of the embodiments of the present disclosure, there is provided an authentication method, being applicable to a second server, including: receiving a first authentication request sent by an Internet of Things (IoT) device; and performing authentication on the IoT device in cooperation with a first server, wherein the first server is a server which is preset to be connectable with the IoT device, and the second server is a server which is not preset to be connectable with the IoT device.

According to a fourth aspect of the embodiments of the present disclosure, there is provided an authentication apparatus, being applicable to an Internet of Things (IoT) device, including: an address determining module configured to determine a first address of a first server which is preset to be connectable with the IoT device and a second address of at least one second server which is not preset to be connectable with the IoT device: an authentication request sending module configured to send a first authentication request to the at least one second server according to the second address, wherein the first authentication request at least carries authentication information of the IoT device and the first address; and a response receiving module configured to receive an authentication response for the first authentication request sent by the at least one second server to determine whether an authentication is passed according to the authentication response.

According to a fifth aspect of the embodiments of the present disclosure, there is provided an authentication apparatus, being applicable to a first server, including: an authentication request receiving module configured to receive a second authentication request sent by at least one second server, wherein the second authentication request at least carries authentication information of an Internet of Things (IoT) device and a certificate of the at least one second server, the first server is a server which is preset to be connectable with the IoT device, and the at least one second server is a server which is not preset to be connectable with the IoT device: an authentication module configured to perform authentication on the at least one second server according to the certificate, and perform authentication on the IoT device according to the authentication information; and a response sending module configured to send an authentication response to the at least one second server according to a result of authentication.

According to a sixth aspect of the embodiments of the present disclosure, there is provided an authentication apparatus, being applicable to a second server, including: an authentication request receiving module configured to receive a first authentication request sent by an Internet of Things (IoT) device; and an authentication module configured to perform authentication on the IoT device in cooperation with a first server, wherein the first server is a server which is preset to be connectable with the IoT device, and the second server is a server which is not preset to be connectable with the IoT device.

According to a seventh aspect of the embodiments of the present disclosure, there is provided an electronic device, including: a processor; and a memory configured to store a computer program: where the computer program, when executed by the processor, causes the processor to perform the above authentication methods.

According to an eighth aspect of the embodiments of the present disclosure, there is provided a computer-readable storage medium storing a computer program, where the computer program, when executed by a processor, causes the processor to perform the steps in the above authentication methods.

According to the embodiments of the present disclosure, the IoT device can send the first authentication request to the second server according to the second address (for example, a link and an internet protocol (IP) address), and the first authentication request can carry the first address of the first server and the authentication information of the IoT device, therefore, the at least one second server can determine the first server according to the first address; further, since the authentication information is stored in the first server, the at least one second server can perform authentication on the IoT device in cooperation with the first server, and establish the communication connection with the IoT device in response to that the authentication is passed.

Therefore, the IoT device is not limited to communicating with the first server, but also can communicate with the at least one second server other than the first server, thereby realizing a cross-platform and cross-ecological connection, making a communication operation of the IoT device more flexible and facilitating the acquisition of diversified information.

It should be understood that the above general descriptions and subsequent detailed descriptions are merely illustrative and explanatory, and shall not constitute limitation to the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1A is a schematic flowchart illustrating an authentication method according to an embodiment of the present disclosure.

FIG. 1B is a schematic diagram illustrating an interaction between servers with an IoT device according to an embodiment of the present disclosure.

FIG. 2 is a schematic flowchart illustrating another authentication method according to an embodiment of the present disclosure.

FIG. 3 is a schematic flowchart illustrating yet another authentication method according to an embodiment of the present disclosure.

FIG. 4 is a schematic flowchart illustrating yet another authentication method according to an embodiment of the present disclosure.

FIG. 5 is a schematic flowchart illustrating yet another authentication method according to an embodiment of the present disclosure.

FIG. 6 is a schematic flowchart illustrating yet another authentication method according to an embodiment of the present disclosure.

FIG. 7A is a schematic flowchart illustrating yet another authentication method according to an embodiment of the present disclosure.

FIG. 7B is a schematic diagram illustrating another interaction between servers with an IoT device according to an embodiment of the present disclosure.

FIG. 7C is a schematic diagram illustrating yet another interaction between servers with an IoT device according to an embodiment of the present disclosure.

FIG. 8 is a schematic flowchart illustrating an authentication method according to an embodiment of the present disclosure.

FIG. 9A is a schematic flowchart illustrating another authentication method according to an embodiment of the present disclosure.

FIG. 9B is a schematic diagram illustrating yet another interaction between servers with an IoT device according to an embodiment of the present disclosure.

FIG. 10A is a schematic flowchart illustrating yet another authentication method according to an embodiment of the present disclosure.

FIG. 10B is a schematic diagram illustrating yet another interaction between servers with an IoT device according to an embodiment of the present disclosure.

FIG. 11 is a schematic flowchart illustrating yet another authentication method according to an embodiment of the present disclosure.

FIG. 12 is a schematic flowchart illustrating yet another authentication method according to an embodiment of the present disclosure.

FIG. 13 is a schematic flowchart illustrating yet another authentication method according to an embodiment of the present disclosure.

FIG. 14 is a schematic flowchart illustrating yet another authentication method according to an embodiment of the present disclosure.

FIG. 15 is a schematic flowchart illustrating an authentication method according to an embodiment of the present disclosure.

FIG. 16 is a schematic flowchart illustrating another authentication method according to an embodiment of the present disclosure.

FIG. 17 is a schematic flowchart illustrating yet another authentication method according to an embodiment of the present disclosure.

FIG. 18 is a schematic flowchart illustrating yet another authentication method according to an embodiment of the present disclosure.

FIG. 19 is a schematic flowchart illustrating yet another authentication method according to an embodiment of the present disclosure.

FIG. 20 is a schematic flowchart illustrating yet another authentication method according to an embodiment of the present disclosure.

FIG. 21 is a schematic flowchart illustrating yet another authentication method according to an embodiment of the present disclosure.

FIG. 22 is a schematic block diagram illustrating an authentication apparatus according to an embodiment of the present disclosure.

FIG. 23 is a schematic block diagram illustrating another authentication apparatus according to an embodiment of the present disclosure.

FIG. 24 is a schematic block diagram illustrating yet another authentication apparatus according to an embodiment of the present disclosure.

FIG. 25 is a schematic block diagram illustrating yet another authentication apparatus according to an embodiment of the present disclosure.

FIG. 26 is a schematic block diagram illustrating yet another authentication apparatus according to an embodiment of the present disclosure.

FIG. 27 is a schematic block diagram illustrating yet another authentication apparatus according to an embodiment of the present disclosure.

FIG. 28 is a schematic block diagram illustrating an authentication apparatus according to an embodiment of the present disclosure.

FIG. 29 is a schematic block diagram illustrating another authentication apparatus according to an embodiment of the present disclosure.

FIG. 30 is a schematic block diagram illustrating yet another authentication apparatus according to an embodiment of the present disclosure.

FIG. 31 is a schematic block diagram illustrating yet another authentication apparatus according to an embodiment of the present disclosure.

FIG. 32 is a schematic block diagram illustrating yet another authentication apparatus according to an embodiment of the present disclosure.

FIG. 33 is a schematic block diagram illustrating an authentication apparatus according to an embodiment of the present disclosure.

FIG. 34 is a schematic block diagram illustrating another authentication apparatus according to an embodiment of the present disclosure.

FIG. 35 is a schematic block diagram illustrating yet another authentication apparatus according to an embodiment of the present disclosure.

FIG. 36 is a schematic block diagram illustrating yet another authentication apparatus according to an embodiment of the present disclosure.

FIG. 37 is a schematic block diagram illustrating yet another authentication apparatus according to an embodiment of the present disclosure.

### DETAILED DESCRIPTION OF THE EMBODIMENTS

Exemplary embodiments will be described in detail herein, examples of which are illustrated in the accompanying drawings. When the following descriptions involve the drawings, like numerals in different drawings refer to like or similar elements unless otherwise indicated. Implementations described in the following exemplary embodiments do not represent all implementations consistent with the present disclosure. Rather, they are merely examples of apparatuses and methods consistent with some aspects of the present disclosure as detailed in the appended claims.

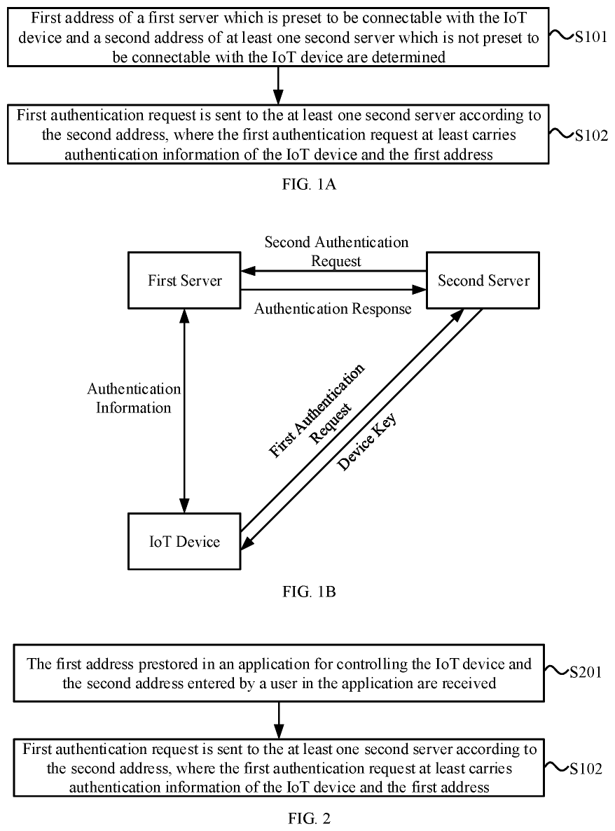

FIG. 1A is a schematic flowchart illustrating an authentication method according to an embodiment of the present disclosure. The authentication method in this embodiment can be applied to an Internet of Things (IoT) device including, but not limited to, a smart home (for example, an air conditioner, a television, a sweeping robot, and the like), a smart wearable device (for example, a bracelet, virtual reality (VR) glasses, and the like).

As shown in FIG. 1A, the authentication method may include steps S101 and S102.

In step S101, a first address of a first server which is preset to be connectable with the IoT device and a second address of at least one second server which is not preset to be connectable with the IoT device are determined.

It should be noted that the first server which is preset to be connectable with the IoT device refers to a server to which the IoT device is connected by default. In general, the server connected by default does not need to be configured by a user, and the IoT device can automatically connect to a preset server after configuring a network. The at least one second server which is not preset to be connectable with the IoT device refers to at least one server to which the IoT device is not connected by default. Specifically, at least one second server can be set using a device configuration interface. In addition, the first server which is preset to be connectable with the IoT device can be a server that is set/configured for the first time, and the at least one second server which is not preset to be connectable with the IoT device can be at least one server that is not set/configured for the first time.

In step S102, a first authentication request is sent to the at least one second server according to the second address, where the first authentication request at least carries authentication information of the IoT device and the first address.

In an embodiment, the IoT device can be configured with a preset connectable server, which is referred to as the first server in this embodiment. For example, the first server can be a cloud server on a cloud platform built by a manufacturer A to which the IoT device belongs. The second server is not a server which is not preset to be connectable with the IoT device. For example, the second server can be a cloud server on a cloud platform built by a manufacturer B to which other IoT devices belong.

In the related art, the IoT device can only communicate with the first server, and cannot communicate with the second server. However, information in each server is limited, and information in different servers can be different. In the case that the IoT device can only access the first server, the IoT device can only obtain information from the first server, which limits the communication flexibility of the IoT device.

One of reasons why the IoT device cannot communicate with the second server is that a server communicating with the IoT device needs to perform authentication on the IoT device first, and communicates with the IoT device only after the authentication is passed. The authentication of the IoT device generally needs to be performed based on the authentication information of the IoT device. However, the authentication information is generally only preset in the first server which is preset to be connectable with the IoT device, but not in the second server. Therefore, the authentication of the IoT device by the second server cannot be passed, and thus a communication connection between the second server and the IoT device cannot be established.

According to the embodiments of the present disclosure, the IoT device can send the first authentication request to the second server according to the second address (for example, a link and an internet protocol (IP) address, and the like), and the first authentication request can carry the first address of the first server and the authentication information of the IoT device, therefore, the at least one second server can determine the first server according to the first address: further, since the authentication information is stored in the first server, the at least one second server can perform authentication on the IoT device in cooperation with the first server, and establish the communication connection with the IoT device in response to that the authentication is passed.

Therefore, the IoT device is not limited to communicating with the first server, but also can communicate with the at least one second server other than the first server, thereby realizing a cross-platform and cross-ecological connection, making a communication operation of the IoT device more flexible and facilitating the acquisition of diversified information.

FIG. 1B is a schematic diagram illustrating an interaction between servers with an IoT device according to an embodiment of the present disclosure. As shown in FIG. 1B, the second server can perform authentication on the IoT device in cooperation with the first server, which can be realized in the following manner.

The second server can send a second authentication request to the first server, and the second authentication request carries the authentication information and a certificate of the second server.

The first server can perform authentication on the second server based on the certificate in the second authentication request, and perform authentication on the IoT device based on the authentication information in the second authentication request. If the authentication of the second server is passed and the authentication of the IoT device is passed, an authentication success response can be fed back to the second server; and if the authentication of the second server is failed or the authentication of the IoT device is failed, an authentication failure response can be fed back to the second server.

After receiving the authentication response from the first server, the second server can further send the authentication response to the IoT device. For example, if the authentication response from the first server is the authentication success response, the authentication success response can be sent to the IoT device. For example, if the authentication response from the first server is the authentication failure response, the authentication failure response can be sent to the IoT device.

Further, if the authentication of the IoT device is passed, the second server can establish a communication connection with the IoT device and exchange information with the IoT device.

It should be noted that the authentication information in the IoT device can be preconfigured by the first server, and the IoT device can also send an authentication request carrying the authentication information to the first server, so as to establish a communication connection with the first server.

FIG. 2 is a schematic flowchart of another authentication method according to an embodiment of the present disclosure. As shown in FIG. 2, determining the first address of the first server which is preset to be connectable with the IoT device and the second address of the at least one second server which is not preset to be connectable with the IoT device includes: in step S201, the first address prestored in an application for controlling the IoT device and the second address entered by a user in the application are received.

In an embodiment, an application in a mobile terminal (for example, a mobile phone, a tablet computer, a personal computer, a wearable device, and the like) can be used to control the IoT device, and a network can be configured for the IoT device through the application.

The application for controlling the IoT device can be an application corresponding to the first server, and thus the address of the first server, i.e., the first address, can be prestored in the application. The second address, as the address of the second server, is not prestored in the application. A user can select one or more second servers as needed, input addresses of the second servers into the application, and then configure the addresses of the second servers to the IoT device through the application.

In an embodiment, the authentication information can include at least one of a device name or a product key.

In an embodiment, the first server can store the authentication information. After receiving the second authentication request sent by the second server, the first server can obtain the device name and the product key in the second authentication request. Further, it is possible to query whether the device name in the second authentication request exists in stored device names, if the device name exists in the stored device names, the product key corresponding to the queried device name can be further determined in stored product keys, and a hash value of the determined product key and a hash value of the product key obtained from the second authentication request can be calculated: if the two hash values are the same, the authentication of the IoT device is passed; and if the two hash values are different, the authentication of the IoT device is failed.

In an embodiment, the product key can include at least one of a public key issued by a product private key, a physical address of the IoT device or a universal unique identifier (UUID) of the IoT device.

In an embodiment, the first server obtains the authentication information of the IoT device through the second server. The authentication information may include the device name and the product key. The first server can obtain a product key corresponding to the device name according to a prestored corresponding relationship between device name and product key, and compare the prestored product key with the product key included in the authentication request, if the prestored product key and the product key included in the authentication request are consistent, it means that the product key in the authentication request is correct and the authentication is passed. In an example, the first server can obtain a product key (a private key) corresponding to the device name according to a stored corresponding relationship between device name and product key (private key), and calculate the product key (a public key) in the authentication request based on the product key (the private key), if the corresponding product key (the public key) can be generated based on the product key (the private key), it means that the authentication is passed.

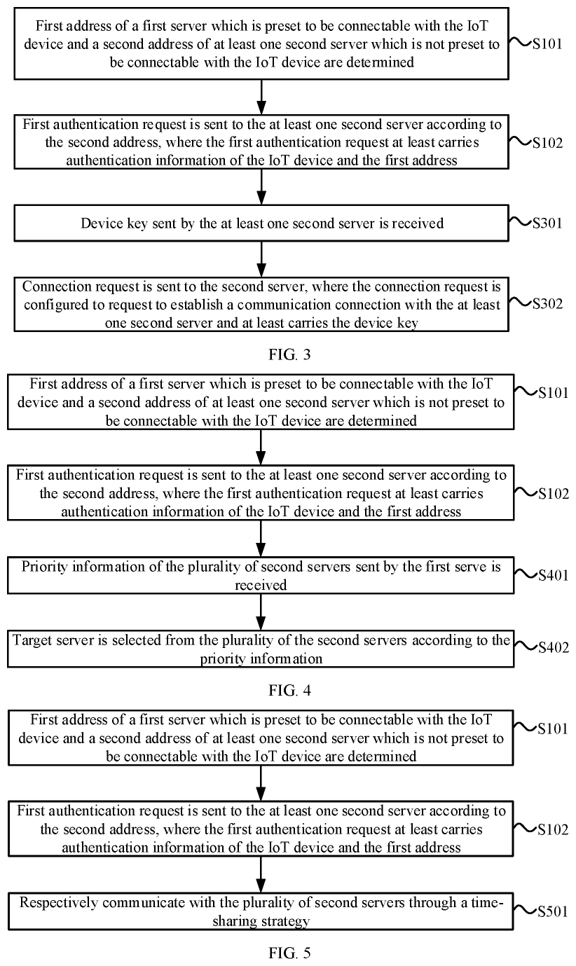

FIG. 3 is a schematic flowchart illustrating yet another authentication method according to an embodiment of the present disclosure. As shown in FIG. 3, when it is determined that the authentication is passed, the method further includes steps S301 and S302.

In step S301, a device key sent by the at least one second server is received.

In step S302, a connection request is sent to the second server, where the connection request is configured to request to establish a communication connection with the at least one second server and at least carries the device key.

In an embodiment, when it is determined that the authentication is passed according to the authentication response from the first server, the second server can send an authentication response and the device key to the IoT device.

Accordingly, when it is determined that the authentication is passed according to the authentication response sent by the second server, the IoT device can receive the device key sent by the second server, and then can carry the device key in the connection request when sending the connection request to the second server.

On the one hand, the second server can calculate a hash value of the device key sent to the IoT device: on the other hand, the second server can calculate a hash value for the device key obtained from the connection request, and then compare the two hash values, if the two hash values are the same, the second server establishes a communication connection with the IoT device; and if the two hash values are different, the second server refuses to establish the communication connection with the IoT device.

It should be noted that the product key and the device key in the embodiment of the present disclosure are essentially keys, but applicable objects are different. The product key is preconfigured for a batch of products, for example, a product key is preconfigured for IoT devices with a same model, that is, this batch of products has the same product key. The device key is configured for respective IoT devices respectively, and different IoT devices have different device keys.

FIG. 4 is a schematic flowchart illustrating yet another authentication method according to an embodiment of the present disclosure. As shown in FIG. 4, the at least one second server includes a plurality of second servers, and the method further includes steps S401 and S402.

In step S401, priority information of the plurality of second servers sent by the first serve is received.

In step S402, a target server is selected from the plurality of second servers according to the priority information.

In an embodiment, when the IoT device sends the first authentication request to a plurality of second servers, the plurality of second servers can send second authentication requests to the first server respectively. According to the received plurality of second authentication requests, the first server can determine that the IoT device needs to establish communication connections with the plurality of second servers.

The first server can determine priority information of each of the plurality of second servers according to a first preset rule and send the determined priority information to the IoT device. For example, the first server can determine a type of a service provided by the second server for the IoT device, and determine a priority according to the type. For example, if the type of the service provided is video communication, the priority can be relatively high; and if the type of the service provided is text communication, the priority can be relatively low. For example, the first server can predict a response speed of the second server when communicating with the IoT device, and the faster the response speed, the higher the priority.

Further, the IoT device can select one or more target servers from the plurality of second servers to establish communication connections according to the priority information. For example, the IoT device receives device keys sent by the target servers, and establishes communication connections with the target servers by sending connection requests carrying a device key. For example, the IoT device can only select a second server with the highest priority as the target server, only receive the device key sent by the target server, and then only send the connection request carrying the device key to the target server, so as to establish a communication connection with the target server. Therefore, the ability of controlling, by the first server, the IoT device to connect with the second server can be improved.

It should be noted that, the first server can determine the priority information for all the second servers, or can also perform authentication according to the second authentication request sent by each second server first, and then determine the priority information only for one or more second servers that have passed the authentication.

FIG. 5 is a schematic flowchart illustrating yet another authentication method according to an embodiment of the present disclosure. As shown in FIG. 5, the at least one second server includes a plurality of second servers, and after establishing communication connections with the plurality of second servers respectively, the method further includes: in step S501, respectively communicating with the plurality of second servers through a time-sharing strategy.

In an embodiment, the IoT device can communicate with the plurality of second servers respectively after establishing communication connections with the plurality of second servers respectively. The strategy used for communication can be a time-sharing strategy, for example, the IoT device can communicate with different second servers in different time domain resources, which is beneficial to reduce the communication bandwidth and communication power required by the IoT device. In addition, information sent by the IoT device in different time domain resources can be different, which is beneficial to avoid sending the information to a wrong server, thereby ensuring the security of the communication.

Further, the plurality of second servers can jointly analyze information from the IoT device, for example, the second servers can use federated learning to analyze the information from the IoT device.

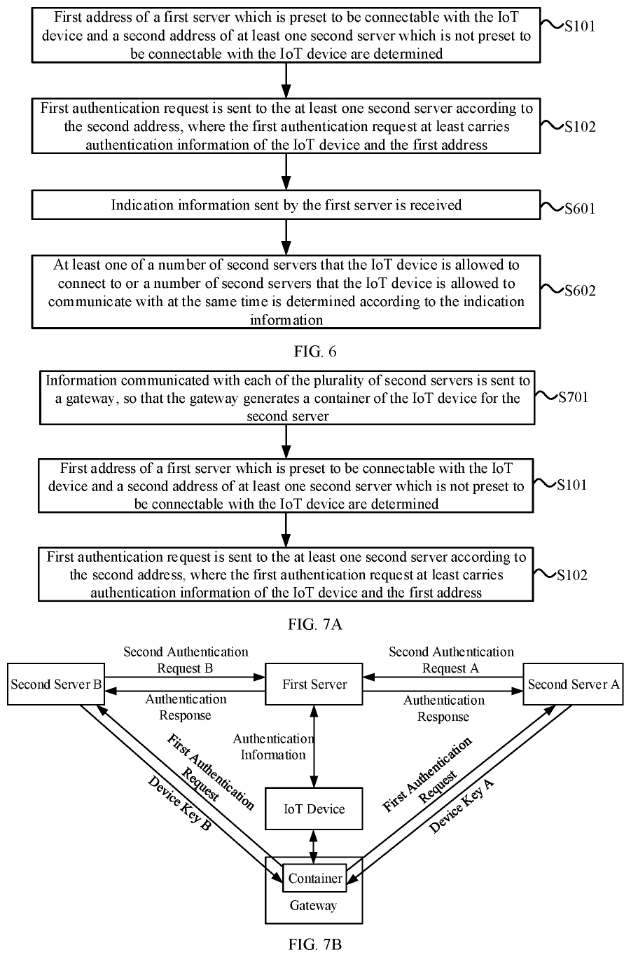

FIG. 6 is a schematic flowchart illustrating yet another authentication method according to an embodiment of the present disclosure. As shown in FIG. 6, the at least one second server includes a plurality of second servers, and the method further includes steps S601 and S602.

In step S601, indication information sent by the first server is received.

In step S602, at least one of a number of second servers that the IoT device is allowed to connect to or a number of second servers that the IoT device is allowed to communicate with at the same time is determined according to the indication information.

In an embodiment, when the IoT device sends the first authentication request to a plurality of second servers, the plurality of second servers can send second authentication requests to the first server respectively. The first server can determine that the IoT device needs to establish communication connections with the plurality of second servers according to the received plurality of second authentication requests.

The first server can determine the number of second servers that the IoT device is allowed to connect to and/or the number of second servers that the IoT device is allowed to communicate with at the same time according to a second preset rule, and then generate indication information and send the indication information to the IoT device. The first server can determine the type, processing capacity, communication bandwidth and other parameters of the IoT device, and then determine the number of second servers according to one or more of these parameters. Taking the number of second servers that the IoT device is allowed to connect to as an example, the processing capacity can be positively correlated with this number, and the communication bandwidth can also be positively correlated with this number. The number corresponding to a communication type of IoT device (for example, a television) is relatively high, and the number corresponding to a non-communication type of IoT device (for example, an air conditioner, a refrigerator, a washing machine, and the like) is relatively low:

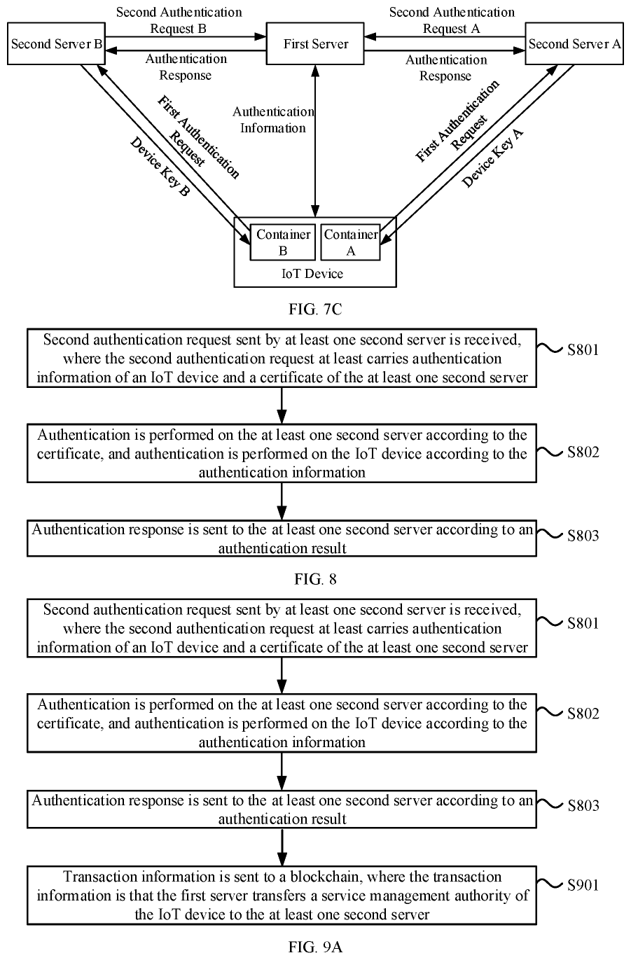

FIG. 7A is a schematic flowchart illustrating another authentication method according to an embodiment of the present disclosure. As shown in FIG. 7A, the at least one second server includes a plurality of second servers, and the method further includes: in step S701, information communicated with each of the plurality of second servers is sent to a gateway, so that the gateway generates a container of the IoT device for the second server. In an embodiment, after establishing communication connections with the plurality of second servers, if the IoT device directly communicates with the plurality of second servers, it is necessary for the IoT device to establish interfaces with the plurality of second servers respectively, and the IoT device needs to determine the logic of communication with the plurality of second servers by itself and comply with the logic when communicating, which will lead to unnecessary waste of resources (for example, electricity) for the IoT device to handle the communication logic.

By sending information communicated with each second server to the gateway, the gateway can generate a container of the IoT device for each second server, and then the container can communicate directly with the second server. For example, for two second servers, two containers can be generated, one container can communicate with a second server, and the other container can communicate with another second server. Since the containers are in the gateway, the processing of communication logic between the plurality of containers and the plurality of second servers can be realized by the gateway, and the IoT device only needs to send and receive information, which is beneficial to save resources of the IoT device.

FIG. 7B is a schematic diagram illustrating another interaction between servers with the IoT device according to an embodiment of the present disclosure. As shown in FIG. 7B, taking the plurality of second servers including a second server A and a second server B as an example, the IoT device can send the information communicating with the second server A and the second server B to the gateway, so that the gateway generates a container of the IoT device for each second server.

The second server A can carry authentication information of the IoT device and a certificate of the second server A in a second authentication request A sent to the first server. When it is determined that the authentication is passed according to an authentication response sent by the first server, the second server A can send a device key A to the IoT device for establishing a communication connection between the IoT device and the second server A. For example, as shown in FIG. 7B, the device key A can be sent to a container established by the gateway for the IoT device.

The second server B can carry authentication information of the IoT device and a certificate of the second server B in a second authentication request B sent to the first server. When it is determined that the authentication is passed according to an authentication response sent by the first server, the second server B can send a device key B to the IoT device for establishing a communication connection between the IoT device and the second server B. For example, as shown in FIG. 7B, the device key B can be sent to the container established by the gateway for the IoT device.

FIG. 7C is schematic diagram illustrating another interaction between servers with the IoT device according to an embodiment of the present disclosure. As shown in FIG. 7C, containers can also be generated in the IoT device. For example, a container A is generated responsible for communicating with a second server A. and a container B is generated responsible for communicating with a second server B.

The second server A can carry authentication information of the IoT device and a certificate of the second server A in a second authentication request A sent to the first server. When it is determined that the authentication is passed according to an authentication response sent by the first server, the second server A can send a device key A to the IoT device for establishing a communication connection between the IoT device and the second server A. For example, as shown in FIG. 7C, the device key A can be sent to a container A.

The second server B can carry authentication information of the IoT device and a certificate of the second server B in a second authentication request B sent to the first server. When it is determined that the authentication is passed according to an authentication response sent by the first server, the second server B can send a device key B to the IoT device for establishing a communication connection between the IoT device and the second server B. For example, as shown in FIG. 7C, the device key B can be sent to a container B.

FIG. 8 is a schematic flowchart illustrating an authentication method according to an embodiment of the present disclosure. The authentication method in this embodiment can be applied to a first server. The first server is a server which is preset to be connectable with an IoT device. The IoT device can include, but is not limited to, a smart home (for example, an air conditioner, a television, a sweeping robot, and the like), a smart wearable device (for example, a bracelet, virtual reality (VR) glasses, and the like).

As shown in FIG. 8, the authentication method can include steps S801 to S803.

In step S801, a second authentication request sent by at least one second server is received, where the second authentication request at least carries authentication information of an Internet of Things (IoT) device and a certificate of the at least one second server, the first server is a server which is preset to be connectable with the IoT device, and the at least one second server is a server which is not preset to be connectable with the IoT device.

In step S802, authentication is performed on the at least one second server according to the certificate, and authentication is performed on the IoT device according to the authentication information.

In step S803, an authentication response is sent to the at least one second server according to a result of authentication.

In an embodiment, the IoT device can be configured with a preset connectable server, which is referred to as the first server in this embodiment. For example, the first server can be a cloud server on a cloud platform built by a manufacturer A to which the IoT device belongs. The second server is not a server which is not preset to be connectable with the IoT device. For example, the second server can be a cloud server on a cloud platform built by a manufacturer B to which other IoT devices belong.

In the related art, the IoT device can only communicate with the first server, and cannot communicate with the second server. However, information in each server is limited, and information in different servers can be different. In the case that the IoT device can only access the first server, the IoT device can only obtain information from the first server, which limits the communication flexibility of the IoT device.

According to the embodiment of the present disclosure, the IoT device can send a first authentication request to the second server according to a second address (for example, a link, an internet protocol (IP) address, and the like), and the first authentication request can carry a first address of the first server and the authentication information of the IoT device, so that the second server can determine the first server according to the first address and send the second authentication request to the first server. The authentication information and the certificate of the second server can be carried in the second authentication request. Then the first server can perform authentication on the second server according to the certificate, and perform authentication on the IoT device according to the authentication information; and send an authentication response to the second server according to the authentication result. The second server establishes a communication connection with the IoT device when it is determined that the authentication is passed according to the authentication response.

Therefore, the IoT device is not limited to communicating with the first server, but also can communicate with the at least one second server other than the first server, thereby realizing a cross-platform and cross-ecological connection, making a communication operation of the IoT device more flexible and facilitating the acquisition of diversified information.

In an embodiment, the second server can perform authentication on the IoT device in cooperation with the first server, which can be realized in the following manner.

The second server can send a second authentication request to the first server, and the second authentication request carries the authentication information and a certificate of the second server.

The first server can perform authentication on the second server based on the certificate in the second authentication request, and perform authentication on the IoT device based on the authentication information in the second authentication request. If the authentication of the second server is passed and the authentication of the IoT device is passed, an authentication success response can be fed back to the second server; and if the authentication of the second server is failed or the authentication of the IoT device is failed, an authentication failure response can be fed back to the second server.

After receiving the authentication response from the first server, the second server can further send the authentication response to the IoT device. For example, if the authentication response from the first server is the authentication success response, the authentication success response can be sent to the IoT device. For example, if the authentication response from the first server is the authentication failure response, the authentication failure response can be sent to the IoT device.

Further, if the authentication of the IoT device is passed, the second server can establish a communication connection with the IoT device and exchange information with the IoT device.

In an embodiment, in response to that the authentication of the at least one second server is passed and the authentication of the IoT device is passed, the authentication response is an authentication success response; and in response to that the authentication of the at least one second server is passed or the authentication of the IoT device is passed, the authentication response is an authentication failure response. That is, only when both the authentication of the second server and the authentication of the IoT device are passed, the authentication success response can be fed back to the second server. As long as one of the authentication of the second server and the authentication of the IoT device is failed, the authentication failure response can be fed back to the second server. The authentication can be performed on second server first, if the authentication is failed, it can be determined that the second server is an illegal server, that is, the second server should not have the authority to communicate with the IoT device, and it is unnecessary to continue to perform the authentication on the IoT device; and if the authentication is successful, continue to perform the authentication on the IoT device.

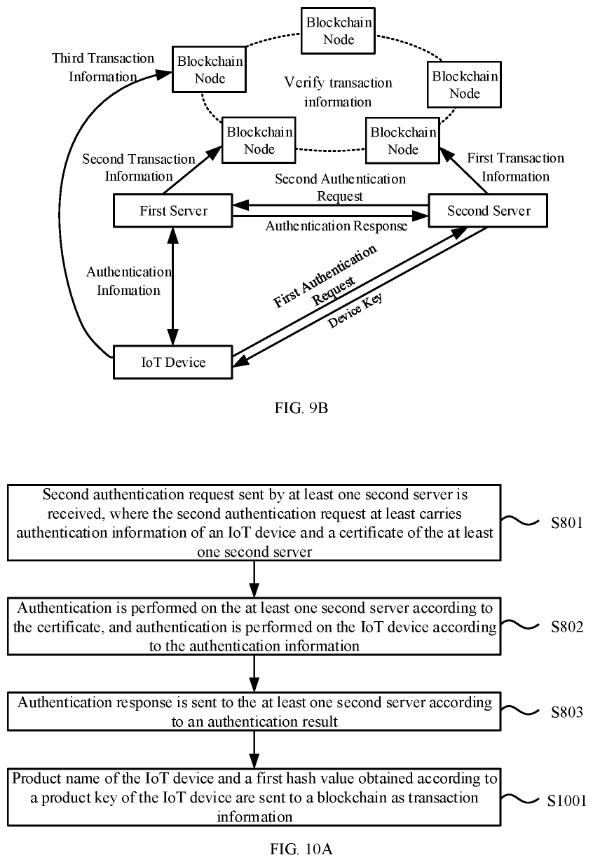

FIG. 9A is a schematic flowchart illustrating another authentication method according to an embodiment of the present disclosure. As shown in FIG. 9A, the method further includes: in step S901, transaction information is sent to a blockchain, where the transaction information is that the first server transfers a service management authority of the IoT device to the at least one second server.

In an example, the first server can further determine whether to transfer the service management authority of the IoT device to the second server after the authentication of the second server and the authentication of the IoT device are passed. If it is determined that the service management authority of the IoT device is transferred to the second server, the second server will mainly perform service management on the IoT device in the subsequent communication process. For example, the second server can perform management on data reading, communication bandwidth, communication contents of the IoT device in the communication process.

FIG. 9B is a schematic diagram illustrating yet another interaction between servers with an IoT device according to an embodiment of the present disclosure. As shown in FIG. 9B, blockchain nodes in a blockchain network can include, but are not limited to, the first server, the second server, and the IoT device.

After receiving the authentication success response from the second server, the IoT device can send third transaction information to the blockchain network. The third transaction information is that the IoT device is connected to the second server. Other nodes in the blockchain nodes than the IoT device, for example, the first server and the second server, can verify the content of the third transaction information, and if the verification is passed, the third transaction information can be recorded in a blockchain ledger. Specifically, the first server can send second transaction information including the content of “canceling the management authority of the IoT device A” to the blockchain network, and sign the content information: other nodes or verification nodes in the blockchain network verify the signature of the transaction and confirm that the transaction is sent by the first server, and at the same time, the other nodes or verification nodes can check that the first server is a current owner of the IoT device, which proves that the transaction information is valid. In an example, the first server can send second transaction information including the content of “the first server transfers the management authority of an IoT device A to the second server” to the blockchain network, and sign the content information: the second server can verify the signature of the transaction, confirm that the transaction is sent by the first server, and sign the content of the transaction, which indicates that the second server confirms that the transaction information is valid: further, other nodes in the blockchain can verify signatures of the first server and the second server, and check that the first server is the current owner of the IoT device, which proves that the transaction information is valid.

The first server can send the second transaction information to the blockchain network, and the second transaction information is that the first server transfers the service management authority of the IoT device to the second server. Other nodes in the blockchain, for example, the second server and the IoT device, can verify the content of the second transaction information, and if the verification is passed, the second transaction information can be recorded in the blockchain ledger.

The second server can send first transaction information to the blockchain network, and the first transaction information is that the second server obtains service management authority of the IoT device. Other nodes in the blockchain, for example, the first server, the IoT device and other second servers, can verify the content of the first transaction information, and if the verification is passed, the first transaction information can be recorded in the blockchain ledger.

In response to that the second transaction information is recorded in the blockchain, the second server can send the first transaction information to the blockchain to obtain the service management authority of the IoT device.

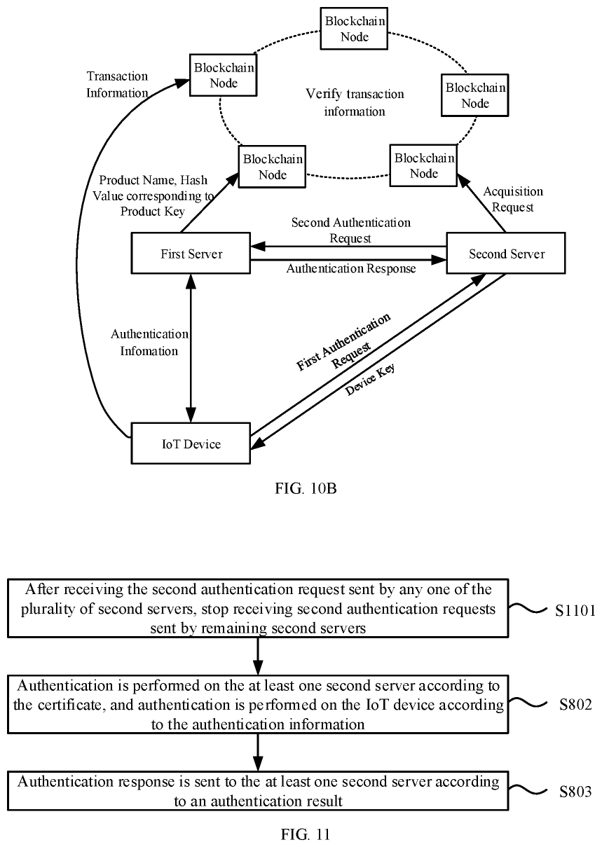

FIG. 10A is a schematic flowchart illustrating yet another authentication method according to an embodiment of the present disclosure. As shown in FIG. 10A, the method further includes: in step S1001, a product name of the IoT device and a first hash value obtained according to a product key of the IoT device are sent to a blockchain as transaction information.

In an embodiment, the first server can send the product name and the first hash value corresponding to the product key to the blockchain as the transaction information. When it is necessary to perform authentication on the IoT device, the second server can obtain the transaction information including the product name from the blockchain according to the product name of the IoT device, and then obtain the second hash value according to the product key sent by the IoT device (for example, a hash operation can be performed on the product key) and compare the second hash value with the first hash value in the transaction information. If the second hash value is the same as the first hash value, it is determined that the authentication is passed; and if the second hash value is different from the first hash value, it is determined that the authentication is failed. Therefore, the authentication between the second server and the first server can be performed through the interaction with the blockchain instead of direct interaction.

FIG. 10B is a schematic diagram illustrating another interaction between servers with the IoT device according to an embodiment of the present disclosure. As shown in FIG. 10B, blockchain nodes in a blockchain network can include, but are not limited to, the first server, the second server, and the IoT device.

The first server can send transaction information to the blockchain. The transaction information can include the product name of the IoT device and the first hash value corresponding to the product key. Other nodes in the blockchain node other than the IoT device, for example, the IoT device and the second server, can verify the content of the transaction information; and if the verification is passed, the transaction information can be recorded in a blockchain ledger.

After receiving an authentication success response from the second server, the IoT device can send transaction information to the blockchain network. The transaction information is that the IoT device is connected to the second server. Other nodes in the blockchain node other than the IoT device, for example, the first server and the second server, can verify the content of the transaction information; and if the verification is passed, the transaction information can be recorded in the blockchain ledger.

After receiving a first authentication request from the IoT device, the second server can obtain the product name and the product key of the IoT device from the first authentication request, and send an acquisition request to the blockchain to acquire transaction information corresponding to the product name, and then obtain the first hash value from the transaction information. The second server can also determine the second hash value according to the product key in the first authentication request, and then compare the first hash value and the second hash value. If the second hash value is the same as the first hash value, it is determined that the authentication is passed; and if the second hash value is different from the first hash value, it is determined that the authentication is failed.

FIG. 11 is a schematic flowchart illustrating yet another authentication method according to an embodiment of the present disclosure. As shown in FIG. 11, the at least one second server includes a plurality of second servers, and receiving the second authentication request sent by the at least one second server includes: in step S1101, after receiving the second authentication request sent by any one of the plurality of second servers, stop receiving second authentication requests sent by remaining second servers.

In an embodiment, the first server can perform authentication on only one second server. In the case that there are a plurality of second servers, if the plurality of second servers send second authentication requests to the first server respectively, the first server can stop receiving the second authentication requests sent by the remaining second servers after receiving the second authentication requests sent by any second server. Therefore, the security problem caused by performing authentication on too many second servers can be avoided.

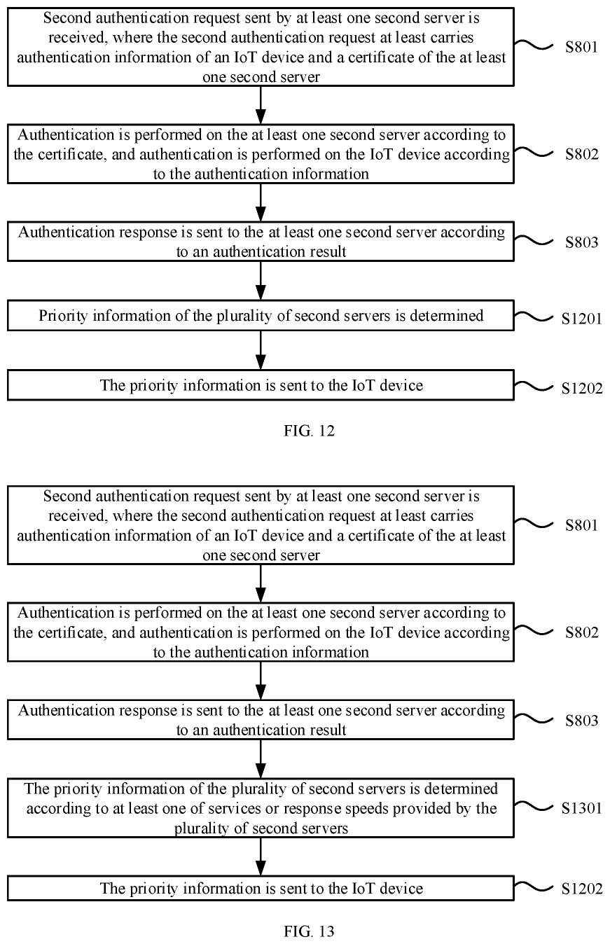

FIG. 12 is a schematic flowchart illustrating yet another authentication method according to an embodiment of the present disclosure. As shown in FIG. 12, the at least one second server includes a plurality of second servers, and the method further includes steps S1201 and S1202.

In step S1201, priority information of the plurality of second servers is determined.

In step S1202, the priority information is sent to the IoT device, where the priority information is configured to instruct the IoT device to select a target server from the plurality of second servers to receive a device key.

In an embodiment, when the IoT device sends the first authentication request to a plurality of second servers, the plurality of second servers can send second authentication requests to the first server respectively, and the first server can determine that it is necessary for the IoT device to establish communication connections with the plurality of second servers according to the received plurality of second authentication requests.

The first server can determine priority information of each second server according to a first preset rule and send the determined priority information to the IoT device. Further, the IoT device can select one or more target servers from the plurality of second servers to receive the device keys according to the priority information, and establish communication connections with the target servers. For example, the IoT device can only select a second server with the highest priority as the target server, and only receive the device key sent by the target server, so as to establish a communication connection with the target server only. Therefore, the ability of controlling, by the first server, the IoT device to connect with the second server can be improved.

FIG. 13 is a schematic flowchart illustrating yet another authentication method according to an embodiment of the present disclosure. As shown in FIG. 13, determining the priority information of the plurality of second servers includes: in step S1301, the priority information of the plurality of second servers is determined according to at least one of services or response speeds provided by the plurality of second servers.

In an embodiment, the first server can determine a type of a service provided by the second server for the IoT device, and determine a priority according to the type. For example, if the type of the service provided is video communication, the priority can be relatively high; and if the type of the service provided is text communication, the priority can be relatively low. For example, the first server can predict a response speed of the second server when communicating with the IoT device, and the faster the response speed, the higher the priority.

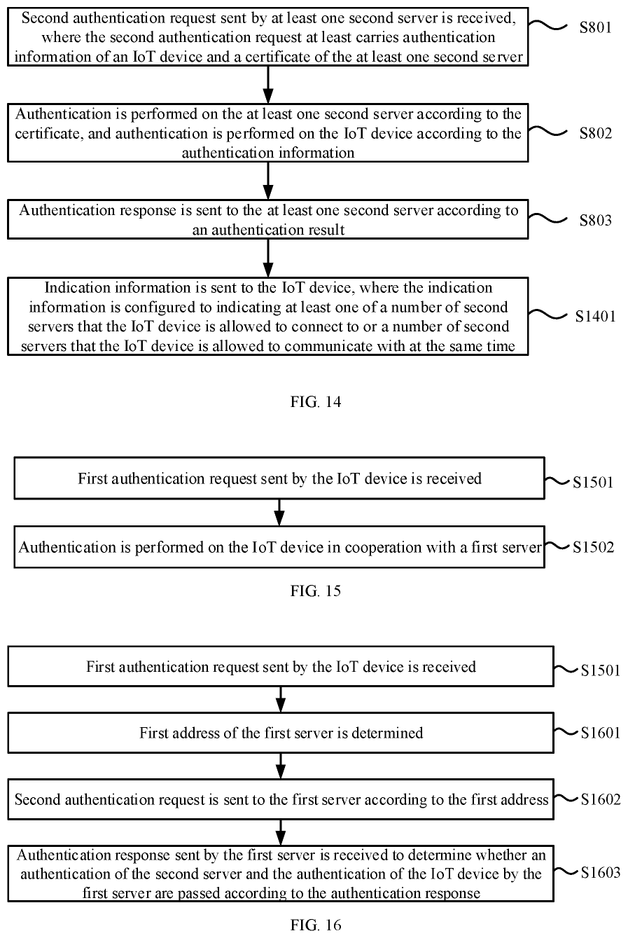

FIG. 14 is a schematic flowchart illustrating yet another authentication method according to an embodiment of the present disclosure. As shown in FIG. 14, the at least one second server includes a plurality of second servers, and the method further includes: in step S1401, indication information is sent to the IoT device, where the indication information is configured to indicating at least one of a number of second servers that the IoT device is allowed to connect to or a number of second servers that the IoT device is allowed to communicate with at the same time.

In an embodiment, when the IoT device sends the first authentication request to a plurality of second servers, the plurality of second servers can send second authentication requests to the first server respectively. According to the received plurality of second authentication requests, the first server can determine that the IoT device needs to establish communication connections with the plurality of second servers.

The first server can determine the number of second servers that the IoT device is allowed to connect to and/or the number of second servers that the IoT device is allowed to communicate with at the same time according to a second preset rule, and then generate indication information and send the indication information to the IoT device. The first server can determine the type, processing capacity, communication bandwidth and other parameters of the IoT device, and then determine the number of second servers according to one or more of these parameters. Taking the number of second servers that the IoT device is allowed to connect to as an example, the processing capacity can be positively correlated with this number, and the communication bandwidth can also be positively correlated with this number. The number corresponding to a communication type of IoT device (for example, a television) is relatively high, and the number corresponding to a non-communication type of IoT device (for example, an air conditioner, a refrigerator, a washing machine, and the like) is relatively low:

FIG. 15 is a schematic flowchart illustrating an authentication method according to an embodiment of the present disclosure. The authentication method in this embodiment can be applied to a second server. The second server is a server which is not preset to be connectable with the IoT device. The IoT device includes but is a smart home (for example, an air conditioner, a television, a sweeping robot, and the like), a smart wearable device (for example, a bracelet, virtual reality (VR) glasses, and the like).

As shown in FIG. 15, the authentication method can include steps S1501 and S1502.

In step S1501, a first authentication request sent by the IoT device is received.

In step S1502, authentication is performed on the IoT device in cooperation with a first server.

The first server is a server which is preset to be connectable with the IoT device, and the second server is a server which is not preset to be connectable with the IoT device.

In an embodiment, the IoT device can be configured with a preset connectable server, which is referred to as the first server in this embodiment. For example, the first server can be a cloud server on a cloud platform built by a manufacturer A to which the IoT device belongs. The second server is not a server which is not preset to be connectable with the IoT device. For example, the second server can be a cloud server on a cloud platform built by a manufacturer B to which other IoT devices belong.

In the related art, the IoT device can only communicate with the first server, and cannot communicate with the second server. However, information in each server is limited, and information in different servers can be different. In the case that the IoT device can only access the first server, the IoT device can only obtain information from the first server, which limits the communication flexibility of the IoT device.

One of reasons why the IoT device cannot communicate with the second server is that a server communicating with the IoT device needs to perform authentication on the IoT device first, and communicates with the IoT device only after the authentication is passed. The authentication of the IoT device generally needs to be performed based on the authentication information of the IoT device. However, the authentication information is generally only preset in the first server which is preset to be connectable with the IoT device, but not in the second server. Therefore, the authentication of the IoT device by the second server cannot be passed, and thus a communication connection between the second server and the IoT device cannot be established.

According to the embodiments of the present disclosure, the IoT device can send the first authentication request to the second server according to the second address (for example, a link and an internet protocol (IP) address, and the like), and the first authentication request can carry the first address of the first server and the authentication information of the IoT device, therefore, the second server can determine the first server according to the first address: further, since the authentication information is stored in the first server, the second server can perform authentication on the IoT device in cooperation with the first server, and establish the communication connection with the IoT device in response to that the authentication is passed.

Therefore, the IoT device is not limited to communicating with the first server, but also can communicate with the second server other than the first server, thereby realizing a cross-platform and cross-ecological connection, making a communication operation of the IoT device more flexible and facilitating the acquisition of diversified information.

FIG. 16 is a schematic flowchart illustrating another authentication method according to an embodiment of the present disclosure. As shown in FIG. 16, the first authentication request at least carries authentication information of the IoT device, and performing the authentication on the IoT device in cooperation with the first server includes steps S1601 to S1603.

In step S1601, a first address of the first server is determined. The manner of determining the first address can include at least one of the following: the first address is carried in the first authentication request, or the second server directly obtains the first address from the first authentication request. The second server can store an association relationship between IoT devices with server addresses in advance, and after receiving the first authentication request, the second server can determine the IoT device corresponding to the device identification, and then determine the server address (i.e., the first address) associated with the IoT device according to the association relationship.

In step S1602, a second authentication request is sent to the first server according to the first address, where the second authentication request at least carries the authentication information of the IoT device and a certificate of the second server.

In step S1603, an authentication response sent by the first server is received to determine whether an authentication of the second server and the authentication of the IoT device by the first server are passed according to the authentication response.

In an embodiment, performing the authentication on the IoT device by the second server in cooperation with the first server can be realized in the following manner: the second server can send the second authentication request to the first server, and the second authentication request carries the authentication information and the certificate of the second server.

The first server can perform authentication on the second server based on the certificate in the second authentication request, and perform authentication on the IoT device based on the authentication information in the second authentication request. If the authentication of the second server is passed and the authentication of the IoT device is passed, an authentication success response can be fed back to the second server; and if the authentication of the second server is failed or the authentication of the IoT device is failed, an authentication failure response can be fed back to the second server.

After receiving the authentication response from the first server, the second server can further send the authentication response to the IoT device. For example, if the authentication response from the first server is the authentication success response, the authentication success response can be sent to the IoT device. For example, if the authentication response from the first server is the authentication failure response, the authentication failure response can be sent to the IoT device.

Further, if the authentication of the IoT device is passed, the second server can establish a communication connection with the IoT device and exchange information with the IoT device.

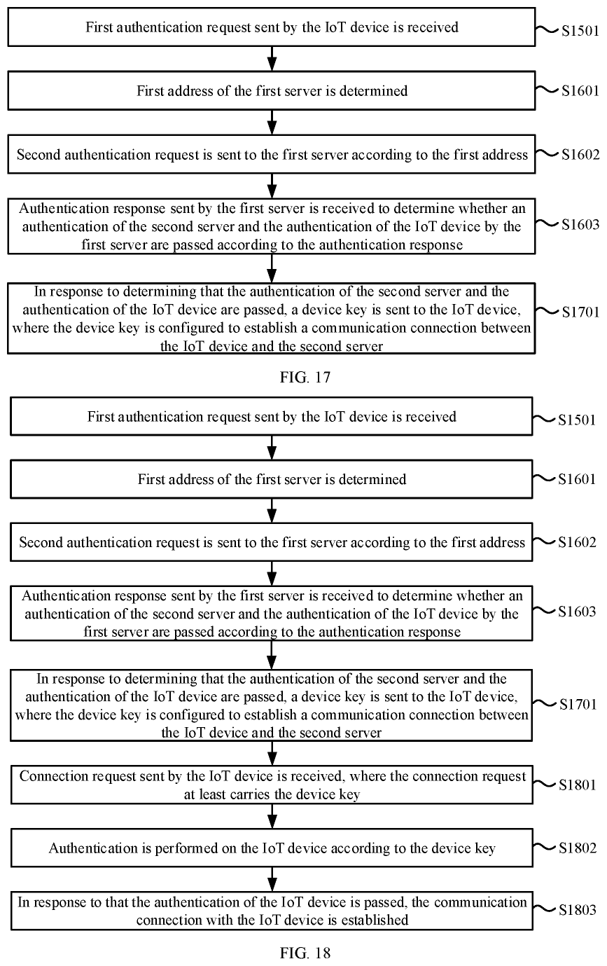

FIG. 17 is a schematic flowchart illustrating yet another authentication method according to an embodiment of the present disclosure. As shown in FIG. 17, the method further includes: in step S1701, in response to determining that the authentication of the second server and the authentication of the IoT device are passed, a device key is sent to the IoT device, where the device key is configured to establish a communication connection between the IoT device and the second server.

In an embodiment, when it is determined that the authentication is passed according to the authentication response from the first server, the second server can send an authentication response to the IoT device and send the device key to the IoT device.

FIG. 18 is a schematic flowchart illustrating yet another authentication method according to an embodiment of the present disclosure. As shown in FIG. 18, the method further includes steps S1801 to S1803.

In step S1801, a connection request sent by the IoT device is received, where the connection request at least carries the device key.

In step S1802, authentication is performed on the IoT device according to the device key.

In step S1803, in response to that the authentication of the IoT device is passed, the communication connection with the IoT device is established.

In an embodiment, when it is determined that the authentication is passed according to the authentication response sent by the second server, the IoT device can receive the device key sent by the second server, and then can carry the device key in the connection request when sending the connection request to the second server.

On the one hand, the second server can calculate a hash value of the device key sent to the IoT device: on the other hand, the second server can calculate a hash value for the device key obtained from the connection request, and then compare the two hash values, if the two hash values are the same, the second server establishes a communication connection with the IoT device; and if the two hash values are different, the second server refuses to establish the communication connection with the IoT device.

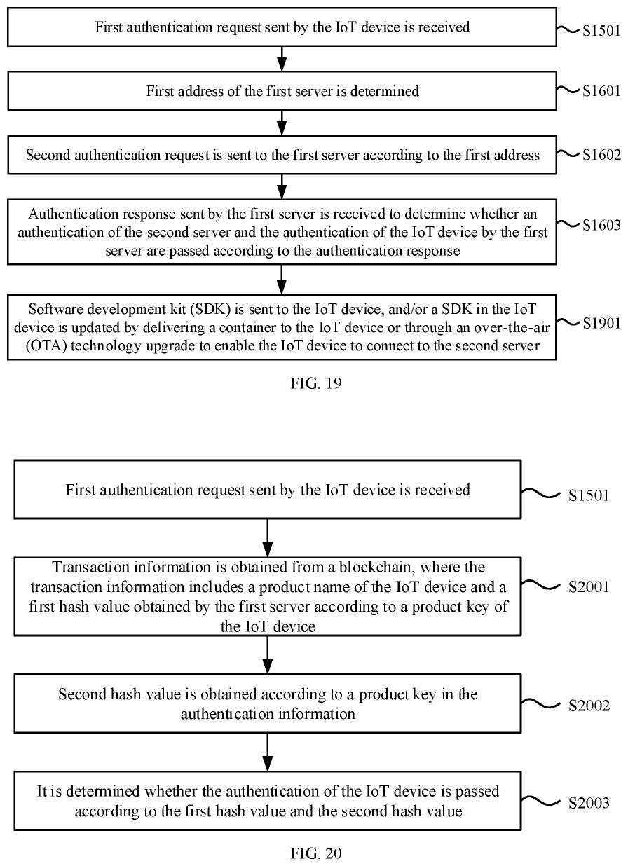

FIG. 19 is a schematic flowchart illustrating yet another authentication method according to an embodiment of the present disclosure. As shown in FIG. 19, the method further includes: in step S1901, a software development kit (SDK) is sent to the IoT device, and/or an SDK in the IoT device is updated by delivering a container to the IoT device or through an over-the-air (OTA) technology upgrade to enable the IoT device to connect to the second server.

In an embodiment, since the IoT device can be preset to be connectable with the first server, the program therein is adapted to the first server, the IoT device can communicate with the first server smoothly. However, the second server is not a server which is not preset to be connectable with the IoT device. In order to enable the IoT device to communicate with the second server smoothly, an SDK can be generated based on functions involved in the communication between the second server and the IoT device, and then sent to the IoT device, so that the IoT device can connect to the second server for communication.

In addition to directly sending the SDK to the IoT device, an SDK in the IoT device (for example, the original SDK or the SDK from the second server) can be updated by delivering a container to the IoT device or by OTA upgrade.

FIG. 20 is a schematic flowchart illustrating yet another authentication method according to an embodiment of the present disclosure. As shown in FIG. 20, the first authentication request at least carries authentication information of the IoT device, and performing authentication on the IoT device in cooperation with the first server includes steps S2001 to S2003.

In step S2001, transaction information is obtained from a blockchain, where the transaction information includes a product name of the IoT device and a first hash value obtained by the first server according to a product key of the IoT device.

In step S2002, a second hash value is obtained according to a product key in the authentication information.

In step S2003, it is determined whether the authentication of the IoT device is passed according to the first hash value and the second hash value.

In an embodiment, the first server can send the product name and the first hash value corresponding to the product key to the blockchain as the transaction information. When it is necessary to perform authentication on the IoT device, the second server can obtain the transaction information including the product name from the blockchain according to the product name of the IoT device, and then obtain the second hash value according to the product key sent by the IoT device (for example, a hash operation can be performed on the product key) and compare the second hash value with the first hash value in the transaction information. If the second hash value is the same as the first hash value, it is determined that the authentication is passed; and if the second hash value is different from the first hash value, it is determined that the authentication is failed. Therefore, the authentication between the second server and the first server can be performed through the interaction with the blockchain instead of direct interaction.

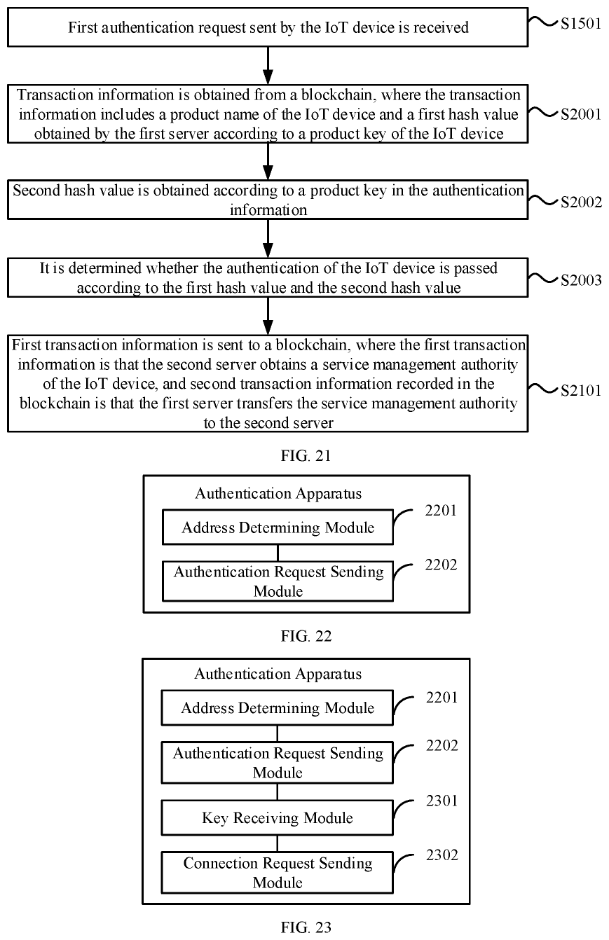

FIG. 21 is a schematic flowchart illustrating yet another authentication method according to an embodiment of the present disclosure. As shown in FIG. 21, the method further includes: in step S2101, first transaction information is sent to a blockchain, where the first transaction information is that the second server obtains a service management authority of the IoT device, and second transaction information recorded in the blockchain is that the first server transfers the service management authority to the second server.

In an embodiment, after receiving the authentication success response from the second server, the IoT device can send third transaction information to the blockchain network. The third transaction information is that the IoT device is connected to the second server. Other nodes in the blockchain nodes than the IoT device, for example, the first server and the second server, can verify the content of the third transaction information, and if the verification is passed, the third transaction information can be recorded in a blockchain ledger.

The first server can send the second transaction information to the blockchain network, and the second transaction information is that the first server transfers the service management authority of the IoT device to the second server. Other nodes in the blockchain, for example, the second server and the IoT device, can verify the content of the second transaction information, and if the verification is passed, the second transaction information can be recorded in the blockchain ledger.

The second server can send first transaction information to the blockchain network, and the first transaction information is that the second server obtains service management authority of the IoT device. Other nodes in the blockchain, for example, the first server, the IoT device and other second servers, can verify the content of the first transaction information, and if the verification is passed, the first transaction information can be recorded in the blockchain ledger.

In response to that the second transaction information is recorded in the blockchain, the second server can send the first transaction information to the blockchain to obtain the service management authority of the IoT device.

An embodiment of the present disclosure also provides an authentication system, including an IoT device, a first server and at least one second server, where the IoT device, the first server and the at least one second server are configured to cooperatively implement the steps in the method described in any of the above embodiments.

An embodiment of the present disclosure also provides an authentication system, including an IoT device, a first server and at least one second server, where the first server is a server which is preset to be connectable with the IoT device, and the at least one second server is a server which is not preset to be connectable with the IoT device, where the IoT device is configured to send a first authentication request to the at least one second server, wherein the first authentication request at least carries authentication information of the IoT device: the at least one second server is configured to send a second authentication request to the first server, wherein the second authentication request at least carries the authentication information and a certificate of the at least one second server; and the first server is configured to perform authentication on the at least one second server according to the certificate, perform authentication on the IoT device according to the authentication information, and send an authentication response to the at least one second server according to a result of authentication.

In an embodiment, the at least one second server is further configured to, in response to determining that the authentication of the at least one second server and the authentication of the IoT device are passed according to the authentication response, send a device key to the IoT device; and the IoT device is further configured to establish a communication connection with the at least one second server based on the device key.

Corresponding to the aforementioned embodiments of the authentication method, the present disclosure also provides embodiments of an authentication apparatus.

FIG. 22 is a schematic block diagram illustrating an authentication apparatus according to an embodiment of the present disclosure. The authentication apparatus in this embodiment can be applied to an IoT device, including but not limited to a smart home (for example, an air conditioner, a television, a sweeping robot, and the like), a smart wearable device (for example, a bracelet, virtual reality (VR) glasses, and the like).

As shown in FIG. 22, the authentication apparatus can include: an address determining module 2201 configured to determine a first address of a first server which is preset to be connectable with the IoT device and a second address of at least one second server which is not preset to be connectable with the IoT device; and an authentication request sending module 2202 configured to send a first authentication request to the at least one second server according to the second address, wherein the first authentication request at least carries authentication information of the IoT device and the first address.

In an embodiment, the address determining module 2202 is configured to receive the first address prestored in an application for controlling the IoT device and the second address entered by a user in the application.

In an embodiment, the authentication information includes at least one of a device name or a product key.

FIG. 23 is a schematic block diagram illustrating another authentication apparatus according to an embodiment of the present disclosure. As shown in FIG. 23, the apparatus further includes: a key receiving module 2301 configured to receive a device key sent by the at least one second server when it is determined that the authentication is passed; and a connection request sending module 2302 configured to send a connection request to the at least one second server, where the connection request is configured to request to establish a communication connection with the at least one second server and at least carries the device key.

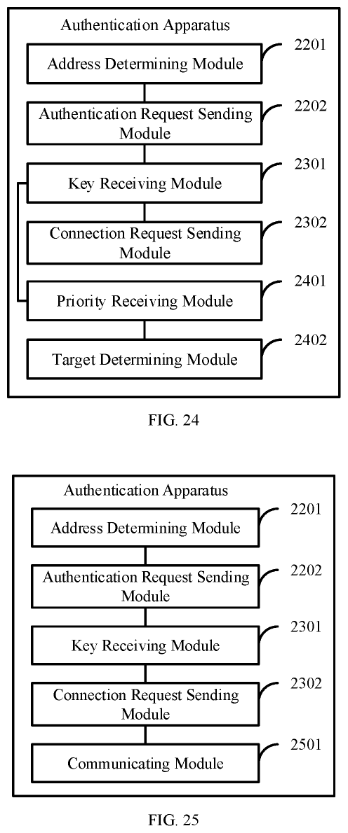

FIG. 24 is a schematic block diagram illustrating yet another authentication apparatus according to an embodiment of the present disclosure. As shown in FIG. 24, the at least one second server includes a plurality of second servers, and the apparatus further includes: a priority receiving module 2401 configured to receive priority information of the plurality of second servers sent by the first serve; and a target determining module 2402 configured to select a target server from the plurality of second servers according to the priority information: where the key receiving module 2301 is configured to receive a device key sent by the target server.

FIG. 25 is a schematic block diagram illustrating yet another authentication apparatus according to an embodiment of the present disclosure. As shown in FIG. 25, the at least one second server includes a plurality of second servers, and the apparatus further includes a communicating module 2501 configured to respectively communicate with the plurality of second servers through a time-sharing strategy after establishing communication connections with the plurality of second servers respectively.

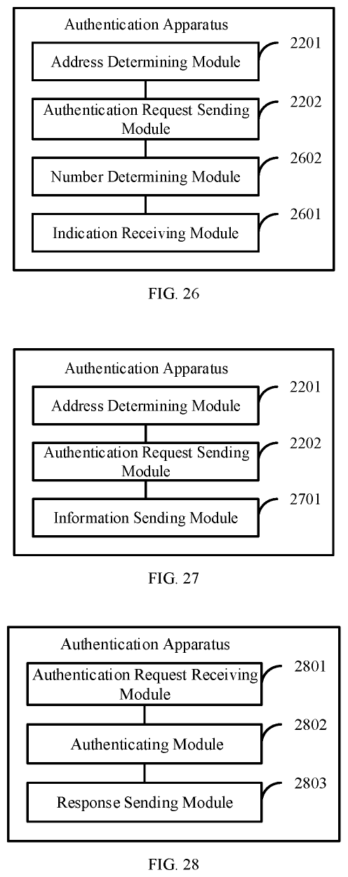

FIG. 26 is a schematic block diagram illustrating yet another authentication apparatus according to an embodiment of the present disclosure. As shown in FIG. 26, the at least one second server includes a plurality of second servers, and the apparatus further includes: an indication receiving module 2601 configured to receive indication information sent by the first server; and a number determining module 2602 configured to determine at least one of a number of second servers that the IoT device is allowed to connect to or a number of second servers that the IoT device is allowed to communicate with at the same time according to the indication information.

FIG. 27 is a schematic block diagram illustrating yet another authentication apparatus according to an embodiment of the present disclosure. As shown in FIG. 27, the at least one second server includes a plurality of second servers, and the apparatus further includes an information sending module 2701 configured to send information communicated with each of the plurality of second servers to a gateway, so that the gateway generates a container of the IoT device for the second server.

FIG. 28 is a schematic block diagram illustrating an authentication apparatus according to an embodiment of the present disclosure. The authentication apparatus in this embodiment can be applied to a first server. The first server is a server which is preset to be connectable with an IoT device. The IoT device can include, but is not limited to, a smart home (for example, an air conditioner, a television, a sweeping robot, and the like), a smart wearable device (for example, a bracelet, virtual reality (VR) glasses, and the like).

As shown in FIG. 28, the authentication apparatus can include an authentication request receiving module 2801 configured to receive a second authentication request sent by at least one second server, wherein the second authentication request at least carries authentication information of an Internet of Things (IoT) device and a certificate of the at least one second server, the first server is a server which is preset to be connectable with the IoT device, and the at least one second server is a server which is not preset to be connectable with the IoT device: an authentication module 2802 configured to perform authentication on the at least one second server according to the certificate, and perform authentication on the IoT device according to the authentication information; and a response sending module 2803 configured to send an authentication response to the at least one second server according to a result of authentication.

In an embodiment, in response to that the authentication of the at least one second server is passed and the authentication of the IoT device is passed, the authentication response is an authentication success response; and in response to that the authentication of the at least one second server is passed or the authentication of the IoT device is passed, the authentication response is an authentication failure response.

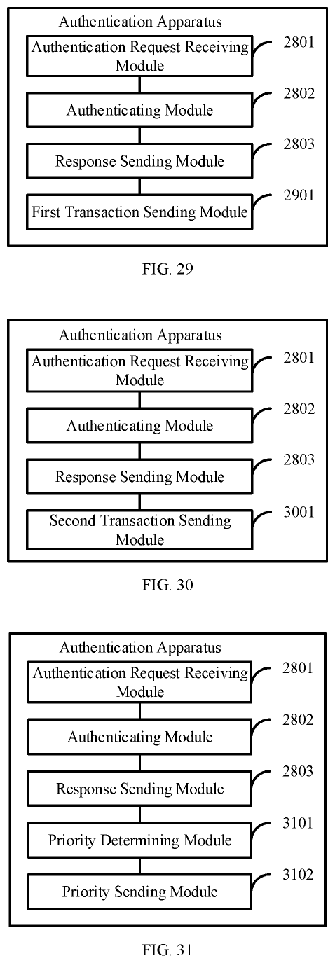

FIG. 29 is a schematic block diagram illustrating another authentication apparatus according to an embodiment of the present disclosure. As shown in FIG. 29, the apparatus further includes a first transaction sending module 2901 configured to send transaction information to a blockchain, where the transaction information is that the first server transfers a service management authority of the IoT device to the at least one second server.

FIG. 30 is a schematic block diagram illustrating yet another authentication apparatus according to an embodiment of the present disclosure. As shown in FIG. 30, the apparatus further includes a second transaction sending module 3001 configured to a product name of the IoT device and a first hash value obtained according to a product key of the IoT device to a blockchain as transaction information.

In an embodiment, the at least one second server includes a plurality of second servers, and the authentication request receiving module 3101 is configured to, after receiving the second authentication request sent by any one of the plurality of second servers, stop receiving second authentication requests sent by remaining second servers.

FIG. 31 is a schematic block diagram illustrating yet another authentication apparatus according to an embodiment of the present disclosure. As shown in FIG. 31, the at least one second server includes a plurality of second servers, and the apparatus further includes: a priority determining module 3101 configured to determine priority information of the plurality of second servers; and an priority sending module 3102 configured to send the priority information to the IoT device, where the priority information is configured to instruct the IoT device to select a target server from the plurality of second servers to receive a device key.

In an embodiment, the priority determining module 3101 is configured to determine the priority information of the plurality of second servers according to at least one of services or response speeds provided by the plurality of second servers.

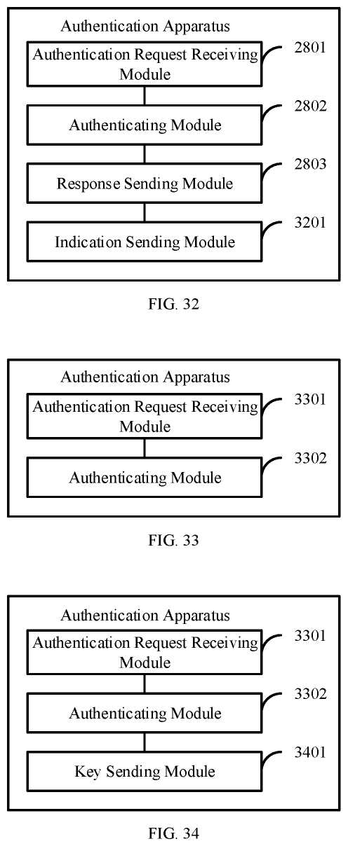

FIG. 32 is a schematic block diagram illustrating yet another authentication apparatus according to an embodiment of the present disclosure. As shown in FIG. 32, the at least one second server includes a plurality of second servers, and the apparatus further includes an indication sending module 3201 configured to send indication information to the IoT device, wherein the indication information is configured to indicating at least one of a number of second servers that the IoT device is allowed to connect to or a number of second servers that the IoT device is allowed to communicate with at the same time.

FIG. 33 is a schematic block diagram illustrating an authentication apparatus according to an embodiment of the present disclosure. The authentication apparatus in this embodiment can be applied to a second server. The second server is a server which is not preset to be connectable with the IoT device. The IoT device can include, but is not limited to, a smart home (for example, an air conditioner, a television, a sweeping robot, and the like), a smart wearable device (for example, a bracelet, virtual reality (VR) glasses, and the like).

As shown in FIG. 33, the authentication apparatus can include: an authentication request receiving module 3301 configured to receive a first authentication request sent by the IoT device; and an authentication module 3302 configured to perform authentication on the IoT device in cooperation with a first server, where the first server is a server which is preset to be connectable with the IoT device, and the second server is a server which is not preset to be connectable with the IoT device.

In an embodiment, the first authentication request at least carries authentication information of the IoT device, and the authentication module 3302 is configured to determine a first address of the first server: send a second authentication request to the first server according to the first address, wherein the second authentication request at least carries the authentication information of the IoT device and a certificate of the second server; and receive an authentication response sent by the first server to determine whether an authentication of the second server and the authentication of the IoT device by the first server are passed according to the authentication response.

FIG. 34 is a schematic block diagram illustrating another authentication apparatus according to an embodiment of the present disclosure. As shown in FIG. 34, the apparatus further includes a key sending module 3401 configured to, in response to determining that the authentication of the second server and the authentication of the IoT device are passed, send a device key to the IoT device, where the device key is configured to establish a communication connection between the IoT device and the second server.

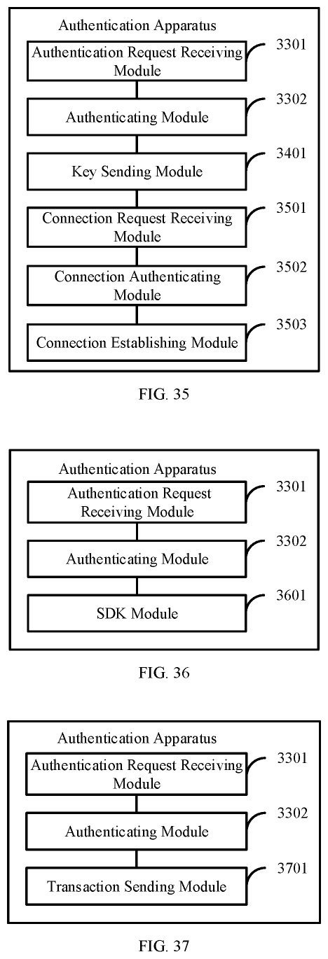

FIG. 35 is a schematic block diagram illustrating yet another authentication apparatus according to an embodiment of the present disclosure. As shown in FIG. 35, the apparatus further includes: a connection request receiving module 3501 configured to receive a connection request sent by the IoT device, where the connection request at least carries the device key: a connection authentication module 3502 configured to perform authentication on the IoT device according to the device key; and; and a connection establishing module 3503 configured to in response to that the authentication of the IoT device is passed, establish the communication connection with the IoT device.

FIG. 36 is a schematic block diagram illustrating yet another authentication apparatus according to an embodiment of the present disclosure. As shown in FIG. 36, the apparatus further includes an SDK module 3601 configured to send a software development kit (SDK) to the IoT device, and/or update an SDK in the IoT device by delivering a container to the IoT device or through an over-the-air (OTA) technology upgrade to enable the IoT device to connect to the second server.

In an embodiment, the first authentication request at least carries authentication information of the IoT device, and the authentication module 3302 is configured to obtain transaction information from a blockchain, where the transaction information includes a product name of the IoT device and a first hash value obtained by the first server according to a product key of the IoT device: obtain a second hash value according to a product key in the authentication information; and determine whether the authentication of the IoT device is passed according to the first hash value and the second hash value.

FIG. 37 is a schematic block diagram illustrating yet another authentication apparatus according to an embodiment of the present disclosure. As shown in FIG. 37, the apparatus further includes a transaction sending module 3701 configured to send first transaction information to a blockchain, wherein the first transaction information is that the second server obtains a service management authority of the IoT device, and second transaction information recorded in the blockchain is that the first server transfers the service management authority to the second server.

With regard to the apparatuses in the above embodiments, the specific way in which each module performs operations has been described in detail in the embodiments of the relevant methods, and will not be described in detail herein.

For the apparatus embodiments, as they substantially correspond to the method embodiments, relevant portions may be referred to the portions of the description of the method embodiments. The apparatus embodiments described above are merely illustrative, and the modules described as separate components may or may not be physically separated, and components indicated as modules may or may not be physical modules, that is, they may be located in a place, or they can be distributed to multiple network modules. Some or all of the modules may be selected according to actual requirements to achieve the objects of the solutions of the embodiments. One of ordinary skill in the art can understand and implement without creative work.

An embodiment of the present disclosure also provides an electronic device, including a processor; and a memory configured to store a computer program. When the computer program is executed by the processor, the authentication method described in any one of the above embodiments is implemented.

An embodiment of the present disclosure also provides a computer-readable storage medium storing a computer program, when the computer program is executed by a processor, the steps in the authentication method described in any one of the above embodiments are implemented.

In the present disclosure, the terms “first” and “second” are only used for descriptive purposes, and cannot be understood as indicating or implying relative importance. The term “plurality of” refers to two or more, unless specifically defined otherwise.

Those skilled in the art will easily think of other embodiments of the present disclosure after considering the description and practicing the disclosure disclosed herein. The present disclosure is intended to cover any variations, applications or adaptive changes of the present disclosure. These variations, applications or adaptive changes follow the general principles of the present disclosure and include common knowledge or conventional technical means in the technical field not disclosed by the present disclosure. The description and the embodiments are to be regarded as exemplary only, and the true scope and spirit of the present disclosure are defined by the appended claims.

It should be understood that the present disclosure is not limited to the exact structure described above and illustrated in the drawings, and various modifications and changes can be made without departing from its scope. The scope of the present disclosure is defined by the appended claims.

It should be noted that the relational terms such as “first” and “second” used herein are merely intended to distinguish one entity or operation from another entity or operation rather than to require or imply any such actual relation or order existing between these entities or operations. Also, the terms “including”, “containing”, or any variation thereof are intended to cover non-exclusive inclusion, so that a process, a method, an article, or a device including a series of elements includes not only those elements but also other elements not listed explicitly or those elements inherent to such process, method, article, or device. Without more limitations, an element defined by the statement “including a . . . ” shall not be precluded from including additional same elements present in the process, method, article or device including the elements.

The methods and apparatuses provided by the embodiments of the present disclosure have been described in detail above. Specific examples are used herein to explain the principles and implementations of the present disclosure. The description of the above embodiments is only used to help understand methods and core ideas in the present disclosure. At the same time, those of ordinary skill in the art can apply some changes in the specific implementation and the scope of application based on the idea of the present disclosure. In conclusion, the content of the present specification should not be construed as any limitation to the present disclosure.

1. An authentication method, comprising:
determining a first address of a first server which is preset to be connectable with an IoT device and a second address of at least one second server which is not preset to be connectable with the IoT device; and
sending a first authentication request to the at least one second server according to the second address, wherein the first authentication request at least carries authentication information of the IoT device and the first address.

2. The method according to claim 1, wherein determining the first address and the second address of the at least one second server connectable with the lot device comprises:
receiving the first address prestored in an application for controlling the IoT device and the second address entered by a user in the application.

3. The method according to claim 1, wherein the authentication information comprises:
a device name, a product key or both.

4. The method according to claim 1, further comprising:
receiving a device key sent by the at least one second server; and
sending a connection request to the at least one second server, wherein the connection request is configured to request a communication connection with the at least one second server and carries the device key.

5. The method according to claim 1, wherein the at least one second server comprises a plurality of second servers, and the method further comprises:
(1) receiving priority information of the plurality of second servers sent by the first server; and
selecting a target server from the plurality of second servers according to the priority information; or
(2) receiving indication information sent by the first server; and
determining at least one of a number of second servers that the IoT device is allowed to connect to or a number of second servers that the IoT device is allowed to communicate with at the same time according to the indication information; or
(3) sending information communicated with each of the plurality of second servers to a gateway, generating with the gateway a container of the IoT device for the second server; or
any combination of (1), (2), and (3).

6. The method according to claim 1, wherein the at least one second server comprises a plurality of second servers, and
after establishing communication connections with the plurality of second servers respectively, the method further comprises:
respectively communicating with the plurality of second servers through a time-sharing strategy.

7. (canceled)

8. (canceled)

9. An authentication method, comprising:
receiving a second authentication request sent by at least one second server, wherein the second authentication request at least carries authentication information of an Internet of Things (IoT) device and a certificate of the at least one second server, the first server is a server which is preset to be connectable with the IoT device, and the at least one second server is a server which is not preset to be connectable with the IoT device;
performing authentication on the at least one second server according to the certificate, and performing authentication on the IoT device according to the authentication information; and
sending an authentication response to the at least one second server according to a result of authentication.

10. The method according to claim 9, wherein
in response to that the authentication of the at least one second server is successful and the authentication of the IoT device is successful, the authentication response is an authentication success response; and
in response to that the authentication of the at least one second server is successful or the authentication of the IoT device is successful, the authentication response is an authentication failure response.

11. The method according to claim 9, further comprising:
sending transaction information to a blockchain, wherein the transaction information is that the first server transfers a service management authority of the IoT device to the at least one second server; or
sending a product name of the IoT device and a first hash value obtained according to a product key of the IoT device to a blockchain as transaction information; or
any combination thereof.

12. (canceled)

13. The method according to claim 9, wherein the at least one second server comprises a plurality of second servers, and receiving the second authentication request sent by the at least one second server comprises:
after receiving the second authentication request sent by any one of the plurality of second servers, stop receiving second authentication requests sent by remaining second servers.

14. The method according to claim 9, wherein the at least one second server comprises a plurality of second servers, and the method further comprises:
determining priority information of the plurality of second servers; and
sending the priority information to the IoT device, wherein the priority information is configured to instruct the IoT device to select a target server from the plurality of second servers to receive a device key.

15. The method according to claim 14, wherein determining the priority information of the plurality of second servers comprises:
determining the priority information of the plurality of second servers according to services or response speeds provided by the plurality of second servers, or both.

16. The method according to claim 9, wherein the at least one second server comprises a plurality of second servers, and the method further comprises:
sending indication information to the IoT device, wherein the indication information is configured to indicating a number of second servers that the IoT device is allowed to connect to or a number of second servers that the IoT device is allowed to communicate with at the same time, or both.

17. An authentication method, comprising:
receiving, with a second server, a first authentication request sent by an Internet of Things (IoT) device; and
performing authentication on the IoT device in cooperation with a first server,
wherein the first server is a server which is preset to be connectable with the IoT device, and the second server is a server which is not preset to be connectable with the IoT device.

18. The authentication method according to claim 17, wherein the first authentication request at least carries authentication information of the IoT device, and performing the authentication on the IoT device in cooperation with the first server comprises:
determining a first address of the first server;
sending a second authentication request to the first server according to the first address, wherein the second authentication request at least carries the authentication information of the IoT device and a certificate of the second server; and
receiving an authentication response sent by the first server to determine whether an authentication of the second server and the authentication of the IoT device by the first server are successful according to the authentication response;
or
obtaining transaction information from a blockchain, wherein the transaction information comprises a product name of the IoT device and a first hash value obtained by the first server according to a product key of the IoT device;
obtaining a second hash value according to a product key in the authentication information; and
determining whether the authentication of the IoT device is successful according to the first hash value and the second hash value;
or any combination thereof.

19. The method according to claim 18, further comprising:
in response to determining that the authentication of the second server and the authentication of the IoT device are successful, sending a device key to the IoT device, wherein the device key is configured to establish a communication connection between the IoT device and the second server; or
sending first transaction information to a blockchain, wherein the first transaction information is that the second server obtains a service management authority of the IoT device, and second transaction information recorded in the blockchain is that the first server transfers the service management authority to the second server; or
any combination thereof.

20. The method according to claim 19, further comprising:
receiving a connection request sent by the IoT device, wherein the connection request at least carries the device key;
performing authentication on the IoT device according to the device key; and
in response to that the authentication of the IoT device is successful, establishing the communication connection with the IoT device.

21. The method according to claim 20, further comprising
sending a software development kit (SDK) to the IoT device; or
updating an SDK in the IoT device by delivering a container to the IoT device or through an over-the-air (OTA) technology upgrade to enable the IoT device to connect to the second server; or
any combination thereof.

22. (canceled)

23. (canceled)

24. An authentication system, comprising an Internet of Things (IoT) device, a first server and at least one second server, wherein the IoT device, the first server and the at least one second server are configured to cooperatively implement the steps in the authentication method according to claim 1.

25. (canceled)

26. (canceled)

27. (canceled)

28. (canceled)

29. (canceled)

30. An electronic device, comprising:
a processor; and
a memory configured to store a computer program;
wherein the computer program, when executed by the processor, causes the processor to perform the authentication method according to claim 1.

31. (canceled)
